(19) United States
(12) Patent Application Publication
(10) Pub. No.: US 2026/0225112 A1
(43) Pub. Date: Aug. 6, 2026

(54) SEPARATOR DISC, COMBINATION OF SEPARATOR DISC STACK AND DISTRIBUTOR, AND CENTRIFUGE

(71) Applicant: GEA WESTFALIA SEPARATOR GROUP GMBH, Oelde (DE)

(72) Inventors: Andreas SCHULZ, Beckum (DE); Kai HELMRICH, Drensteinfurt (DE); Kathrin QUITER, Drensteinfurt (DE); Steffen LAACKMANN, Wadersloh (DE)

(21) Appl. No.: 19/154,052

(22) PCT Filed: Jan. 22, 2024
(86) PCT No.: PCT/EP2024/051415

§ 371 Date: Aug. 6, 2025

(30) Foreign Application Priority Data
Feb. 7, 2023 (DE) 10 2023 102 918.5

(51) Int. Cl. B04B 1/08; B04B 7/14

(52) U.S. Cl. CPC B04B 1/08; B04B 7/14

(57) ABSTRACT

A separator disc for a centrifuge is designed to be arranged in a separator disc stack in the interior of a drum of the centrifuge to clarify or separate a material mixture. The separator disc has a truncated cone shell-like main part, with an inner circumference and an outer circumference, an inner surface, an outer surface, and at least one or more spacing elements. One or more hollow protrusions are formed on the truncated cone shell-like main part. The hollow protrusions having a greater axial extension than the spacing element so that, in a separator disc stack, the hollow protrusions of adjacent separator discs can engage into one another in a form-fitting manner.

### BACKGROUND AND SUMMARY OF THE INVENTION

Exemplary embodiments of the present invention relate to a separator disc, a combination of separator disc stack and distributor, and a centrifuge.

WO 2014/000829 A1, DE 10 2017 128 027 A1 and DE 10 2020 121 419 A1 each disclose a centrifuge designed as a separator with disposable plastic components (single-use technology—single use of pre-qualified plastic parts). Such separators with disposable components are particularly suitable for use in biotechnology or in pharmaceuticals for centrifugal separation of at least two phases of a liquid mixture of substances, such as a suspension.

In such separators, a predominant part and preferably even all of the areas of the rotating system that come into contact with the product consist entirely or substantially of a plastic or a plastic composite material, preferably the drum and the disc stack. The terms separator disc stack, disc stack and disc pack are used synonymously in this document, as are disc and separator disc. Furthermore, the feed system and the discharge system are particularly preferably made of plastic or a plastic composite material.

In centrifuges with separator disc stacks consisting of several individual separator discs—such as the centrifuges described above—the liquid mixture to be processed is fed into the rotating drum in the centrifuge via a centric inlet pipe. From here, the liquid mixture enters a distributor rotating with the drum, which accelerates the mixture to the drum speed and feeds it into a separation chamber in the drum. The drum, together with the distributor and the separator disc stack, is usually driven by a suitable drive. The liquid mixture rises—preferably but not necessarily—through riser channels—which are located inside or on the outer edge of a separator disc stack—into a stack of separator discs. Here, annular gaps/spaces are created for separating or clarifying the liquid mixture by means of conical separator discs arranged one above the other, which are provided with spacer tabs generally arranged radially on them. The cone angle of the separator discs in relation to the axis of rotation is usually and preferably between 30 and 60 degrees.

According to the prior art, but also according to the invention, the separator discs are preferably provided with riser holes arranged on a hole circle and with spacer elements which, when locked in place on the distributor shaft of a distributor, form an intermediate space between adjacent separator discs and riser channels over the height of the disc pack for transportation and for distribution of the liquid to the intermediate spaces.

The spacer plates are designed with different axial thicknesses depending on the product or mixture to be clarified or separated. The riser channels are usually designed as circular or semi-circular holes or slotted holes and placed in a separation zone. This can also be in the area of the outer diameter of the disc. In this case, there may also be riser areas on the outside of the outer diameter of the disc. Accordingly, such separator discs can be provided with recesses on the outer circumference, which form the riser channels or riser areas in the stack of separator discs.

DE10055398C1 discloses a known disc pack consisting of separator discs made of metal. In order to ensure that all discs assume their intended rotational position (alignment and fixation) in the disc pack, this prior art has a “groove and feather key” solution. In this case, the frustoconical disc has a cranked edge on the inner circumference of the disc, which is provided with one or more grooves (receiving openings). These correspond to one or more corresponding feather keys (catches), which are formed on the outer circumference of the distributor shaft, on which the discs are stacked. The rotational position of a disc is therefore only fixed via this “groove and feather key” connection on the inner circumference of the disc or on the outer circumference of the distributor. To ensure that the discs are positioned exactly in relation to each other, the “groove and feather key” connection is designed with a precise fit with very little play, which makes it more difficult to fit and remove the individual discs on the distributor shaft (the discs can grind or jam). Such a precise fit is possible with sheet metal discs with a punched or laser-cut mounting opening (groove), which are mounted on a milled distributor shaft. With injection-molded parts (discs and distributors) made of plastic, however, this solution appears to be very difficult to implement, especially as the achievable tolerances are greater than with corresponding separator discs made of sheet metal. Grinding or clamping during assembly should be avoided as far as possible, as this may result in material abrasion entering the separation chamber, which cannot be tolerated in the biotechnology or pharmaceutical industries.

Against this background, exemplary embodiments of the invention are directed to a solution that is simple in design and easy to implement in terms of process engineering to ensure that the discs are positioned precisely relative to one another in the disc stack. The solution should be particularly suitable for disc packs or disc stacks made of plastic separator discs.

According to an embodiment, a separator disc for a centrifuge, in particular for a separator, is provided, wherein the separator disc is provided to be arranged in a stack of separator discs in a drum interior of a drum of the centrifuge for clarifying or separating a substance mixture, wherein the separator disc has a frustoconical shell-like main body having an inner circumference and an outer circumference, as well as an inner surface and an outer surface, and has at least one or more spacer elements, wherein one or more hollow protrusions are formed on the frustoconical shell-like main body, which protrusions have a greater axial extension than the spacer element, so that, in a separator disc stack, the hollow protrusions of adjacent separator discs can engage into one another in a form-fitting manner.

The hollow protrusions are designed in such a way that they interlock when the separator discs are stacked, thus forcing precise alignment of the discs to one another in a simple manner.

This solution according to the invention is particularly suitable for separator discs and disc packs that are made of plastic as injection-molded parts and have somewhat greater tolerances than corresponding separator discs made of metal due to the manufacturing process. However, it can also be used for separator discs made of other materials, such as metal.

According to a further development, which is however also to be regarded as a separate invention, a separator disc has a frustoconical shell-like main body with an angle to the axis of rotation that is constant radially inwards, so that no crank is formed radially inwards on the separator disc, and that recesses are formed on the inner circumference of the separator discs. In this way, very precise groove and feather key lock between the disc and the distributor neck is no longer required to achieve precise rotational alignment of the separator discs to each other. The fit and its tolerance between the disc and the distributor neck can thus be designed in such a way that it can be easily realized with injection-molded parts and the assembly and disassembly of the disc pack on the distributor neck can be carried out easily and without abrasion.

The separator discs according to the invention can be used in separators of various designs, for example in centrifuges according to WO 2014/000829 A1, DE 10 2017 128 027 A1 or DE 10 2020 121 419 A1, in which a predominant part of and preferably even all of the product-contacting areas of the rotating system are made of a plastic or a plastic composite material, in particular the product-contacting areas of the drum and the disc stack.

A particularly good centering of the separator discs can be achieved if the hollow protrusions are wedge-shaped in an advantageous design. However, other geometries are also conceivable. For example, the hollow protrusions can also be shaped like spherical segments.

The hollow protrusions designed in this way do not create any openings in the separator disc, so that the surface of the respective separator disc is closed in the region of the hollow protrusions.

It is conceivable that one or more of the hollow protrusions are formed on the inner surface of the separator disc, e.g., on the underside of the disc. However, it is also conceivable that one or more of the hollow protrusions are formed on the outer surface of the separator disc, e.g., on the top of the disc.

In an advantageous design, it is then preferred that one or more of the hollow protrusions are formed in a central or outer radial region of the separator disc, wherein the latter complements the locking on the inner circumference particularly well.

A particularly advantageous design is achieved if the spacer elements are designed as radially extending webs and the hollow protrusions are provided in a radial extension of these spacer elements. On the one hand, this ensures good centering of the separator discs in the disc stack and, on the other hand, the separation process in the spaces between the spacer elements is not significantly impaired. In addition, the arrangement of the protrusions on the circumference of the main body of the separator disc can follow the same pitch as the arrangement of the spacer elements on the separator disc.

In an advantageous design, it is then preferred that the wall thicknesses and angles of the hollow protrusions are designed in such a way that, when the hollow protrusions are joined together, a distance between the adjacent discs is produced that corresponds to the height of the spacer elements. In this way, the hollow protrusions themselves act advantageously as additional spacer elements.

The invention then creates a combination of a distributor rotatable in operation and a stack of separator discs of a separator rotatable with the distributor in operation, wherein the separator discs are each designed as described herein, and wherein the distributor has a distributor base and an adjoining distributor shaft, wherein a lowermost separator disc rests on the distributor base, and that the further separator discs of the stack of separator discs are stacked on this lowermost separator disc around the distributor shaft. In this way, the stack of discs is held on the distributor in a simple manner.

It is particularly preferred that the hollow protrusions of adjacent separator discs in the separator disc stack interlock positively and center the separator discs in the separator disc stack at least in circumferential direction and that the distributor base has one or more form-fitting elements which correspond to the hollow protrusion(s) of the lowest separator disc, in which the hollow protrusions of the lowest separator disc engage or receive its hollow protrusions, so that the lowest separator disc is centered in a form-fitting manner on the distributor base. This form-fitting connection between the separator discs and between the disc pack and the distributor not only ensures the rotational alignment of the separator discs, but also better torque transmission from the driven distributor to the disc pack.

In an advantageous design, it is also preferred if the distributor shaft is provided with ribs projecting radially from its outer circumference, which fully or partially engage around the separator discs of the separator disc stack on their inner circumference in a form-fitting manner with edge recesses. It is also preferred that the spacer elements are provided in radial extension of the ribs of the distributor and preferably also the hollow protrusions.

It is further preferred in an advantageous design that the distributor consists entirely or substantially of plastic or a plastic composite material and is manufactured, for example, in a plastic injection-molding process. However, it is also conceivable that the distributor consists entirely or substantially of another material, in particular entirely or substantially of metal.

Furthermore, exemplary embodiments are also directed to a centrifuge, in particular a separator or a solid drum screw centrifuge, wherein a combination of a distributor and a separator disc stack consisting of separator discs according to the invention is placed in the interior of the drum of the centrifuge.

### BRIEF DESCRIPTION OF THE DRAWING FIGURES

In the following, the invention is described in more detail with reference to the figures by means of exemplary embodiments. The invention is not limited to these embodiments, but can also be implemented in other ways or equivalently within the scope of the claims, wherein the figures show as follows:

FIG. 1: shows a perspective view of an example of a separator disc;

FIG. 2: shows a perspective view of an exemplary embodiment of a distributor;

FIG. 3: shows the distributor of FIG. 2 with a separator disc stack of separator discs of the type shown in FIG. 1;

FIG. 4: shows a section through FIG. 3, wherein the section running to the left of the axis of rotation D through a holding rib of the distributor and to the right of the axis of rotation between two ribs of the distributor which are adjacent in the circumferential direction; and

FIG. 5: shows a schematic representation of an exemplary known centrifuge in full section, in which separator discs and distributors made of plastic are used.

Several exemplary embodiments are described in the following description of the figures. The individual features of these exemplary embodiments can also be combined with exemplary embodiments not shown and are also suitable in each case as advantageous designs of the objects described in individual or several of the main claims and sub-claims.

### DETAILED DESCRIPTION

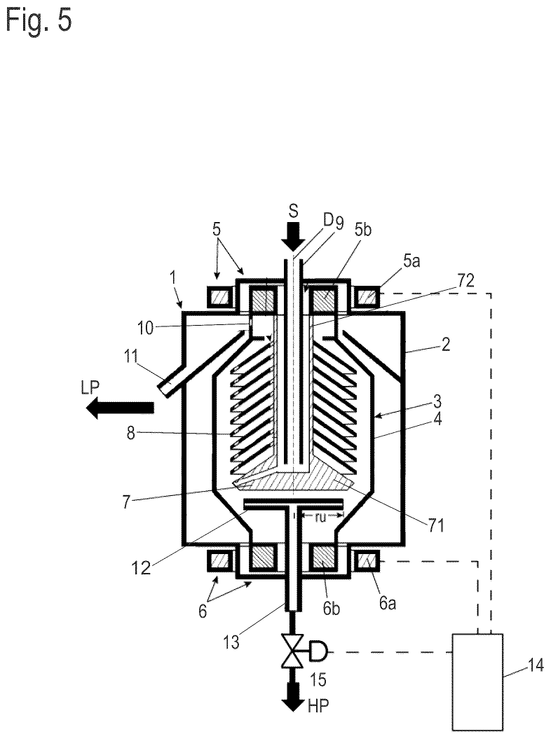

FIG. 5 shows a separator insert 1 of a separator, wherein the separator insert 1 has in each case a housing 2 and a rotor 3 that is inserted into the housing 2 and can rotate relative to the housing 2 during operation. The rotor 3 has an axis of rotation D. This can be aligned vertically, but it can also be aligned differently in space. The term vertical is to be understood broadly in this respect. The terms “up” and “down” refer in each case to a first and a second position of the axis of rotation in the orientation selected in space.

The rotor 3 has a rotatable drum 4. The drum 4 can be rotated by a drive. A preferred design of such a drive is described below. However, the drive can also be implemented in other ways, for example with an electric motor that rotates the drum via a spindle. During operation, the rotor 3 is held in suspension by magnetic bearing devices 5, 6 of a frame not otherwise shown here (known from DE 10 2020 121 419 A1).

During operation, the rotor 3 is rotatably mounted in the frame at two locations axially spaced apart from each other in the direction of the axis of rotation with respective magnetic bearing devices. For this purpose, the separator insert 1 can have an upper rotor magnet 5b and a lower rotor magnet 6b of the magnetic bearing devices 5, 6, wherein the magnetic bearing devices are completed by stator magnets 5a, 6a of the frame (shown here without the rest of the frame). Preferably, form-fitting means can be provided (not shown), which can be designed as projections and recesses in order to hold the housing 2 non-rotatably on the stator magnets 5a, 6a and thus on the frame. The magnetic bearing devices 5, 6 preferably act radially and axially and preferably keep the rotatably mounted rotor 3 suspended in the housing 2 at a distance from it during operation of the separator. This drive is exemplary, but not mandatory. A drum with a drive spindle mounted in roller bearings could also be used within the scope of the invention.

Such a separator with the easily exchangeable separator insert 1, which is preferably made entirely or substantially of plastic, can be useful and advantageous when processing products where it must be ruled out with a very high degree of certainty that impurities are introduced into the product—a flowable suspension S or its phases LP, HP—during centrifugal processing or where cleaning and disinfecting the separator would be very time-consuming or not possible at all.

The housing 2 is preferably also made of a plastic or plastic composite material. The housing 2 can be cylindrical.

The drum 4 is used for centrifugal separation of a flowable suspension S in the centrifugal field into at least two phases LP, HP of different densities, which can be, for example, a lighter liquid phase LP and a heavier solid phase HP.

The drum 4 is preferably cylindrical at least in sections and/or single or double conical in sections. The housing 2 can be designed in the manner of a container, which is advantageously hermetically sealed except for some openings/opening areas.

The drum 4 contains internals, in particular a distributor 7 and a separator disc pack 8, which are preferably also made entirely or predominantly of a plastic or plastic composite material.

The housing 2 and the drum have a feed line in the form of a feed pipe 9 for feeding the suspension S to be separated or clarified into the drum 4, as well as discharge lines 10, 11 or 12, 13 for discharging the phases LP, HP resulting from the centrifugation process first from the drum 4 and then through the housing 2 to the outside. These can be realized as desired, for example as paring discs, free discharge lines or hermetic discharge lines.

A control device 14 is used to control the separator, in this case to control the magnetic bearing devices 5, 6 with the stator magnets 5a, 6a and a valve 15 in the outlet 13.

The feed line extends axially as a vertical feed pipe in the rotating drum 4 into the distributor 7.

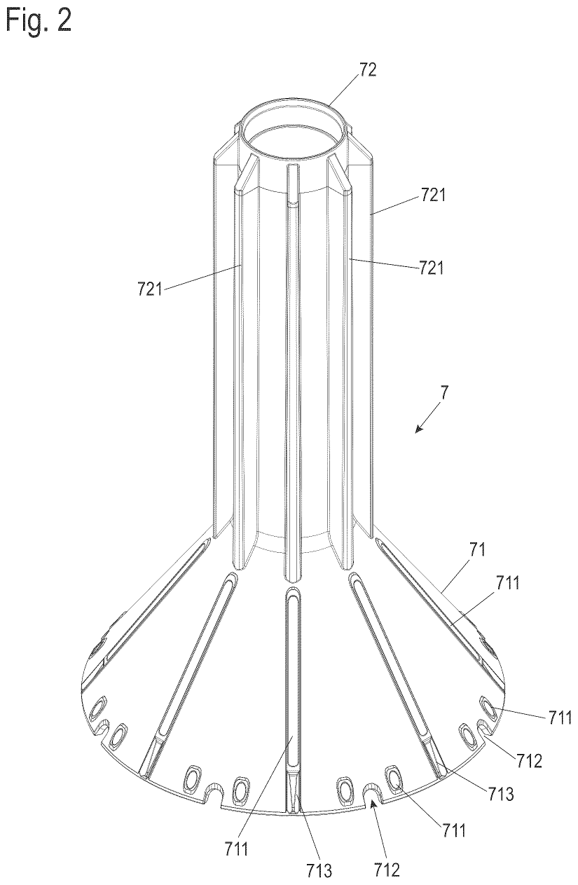

The distributor 7—see also FIG. 2—has a distributor base 71 and a distributor shaft 72. The feed pipe 9 passes through the distributor shaft 72 in sections.

It ends inside the distributor shaft. The incoming liquid mixture is fed through the feed pipe and from there into channels 726 on the underside of the distributor base, which may be bounded by ribs 725. The liquid mixture is fed through these channels 726 on the underside of the distributor base into the separation chamber of the drum 4. The distributor base 71 essentially has a conical frustoconical shape.

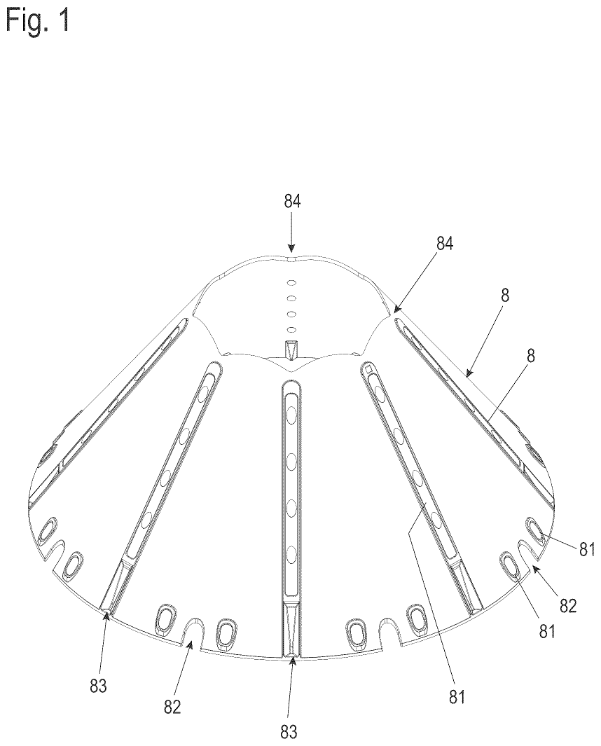

The distributor shaft 72 can also have radially projecting ribs 721 on its outer circumference, which are distributed around the distributor shaft 72 in the circumferential direction. A separator disc stack of separator discs 8 is placed on the distributor shaft 72, which can extend over the entire length or at least that part of the distributor shaft 72 in which the separator disc stack is placed on it. These separator discs 8 are essentially conical in shape or preferably form a main body in the form of a truncated cone shell (FIGS. 1, 3, 4), apart from the functional elements provided locally on them.

The lowest separator disc 8 of this stack of separator discs rests on the conical distributor base 71. A plurality of further conical separator discs 8 are stacked on this lowest separator disc 8. These separator discs 8 are each correspondingly conical or substantially frustoconical in shape.

Spacer elements 81 are also formed on the separator discs 8 as functional elements, distributed around the circumference, which serve and are suitable for spacing the separator discs apart in a defined manner, so that a gap of a defined height is formed between them, which serves as a separating gap. These spacer elements 81 are designed here in the form of web-like projections. These can extend radially. However, they can also have a different geometry such as an arc shape or be arranged at an angle to the surface line.

The separator discs 8 are preferably essentially frustoconical over their entire axial length or form a frustoconical shell-like main body. They have an inner side and an outer side. In FIG. 1, the inside is also the underside. In FIG. 1, the outer side is also the upper side.

The separator discs have an inner circumference and an outer circumference.

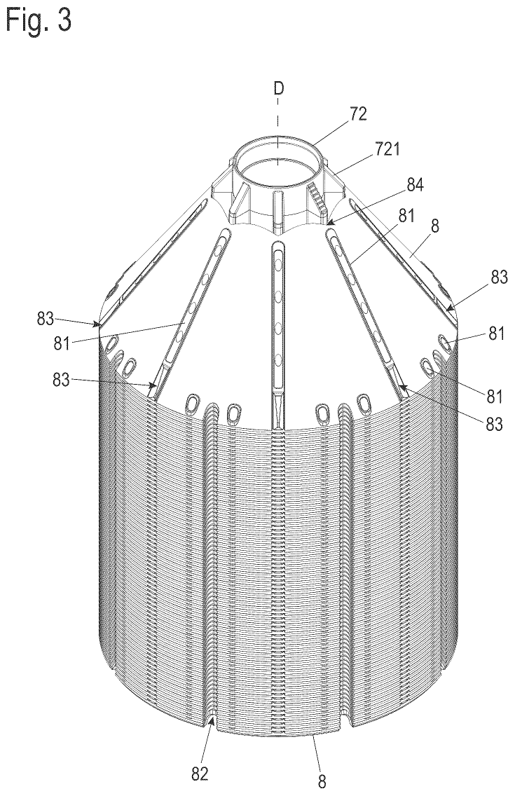

In the assembled position of the separator disc 8 on the distributor shaft, the webs 81 can each lie in radial extension of the ribs 721. In addition to the webs, further spacer elements 81 can be provided, such as point-like or truncated cylinder-like or “circular” spacer elements 81, for example next to openings or edge recesses 82 for forming respective riser channels in the disc stack (see FIGS. 1 and 3). The spacer elements 81 can be formed on the upper side and/or the underside of the separator discs 8.

The separator discs 8 preferably do not have a flange-like, cranked edge section radially inwards, which extends radially in an axial plane. This simplifies the production of the separator discs 8 using the plastic injection-molding process. The separator discs 8 can have circumferentially distributed radial (edge) recesses 84 on the inner circumference corresponding to the ribs 721 of the distributor shaft 72, which serve to engage around the outer radial edge of the ribs in a corresponding manner, so that they are held in the circumferential direction radially inwards on the ribs 721 of the distributor shaft 71 in a form-fitting, torsionally secured manner. The taper angle of the respective separator disc 8 is constant, particularly in this area or substantially over the entire separator disc 8—except for the aforementioned functional elements.

The separator discs 8 can furthermore—preferably in their radially outer regions—have circumferentially distributed one or preferably as further functional elements several corresponding hollow protrusions 83 in the form of bulges, which have a larger axial extension than the spacing of the separator discs of the separator disc stack, so that corresponding hollow protrusions 83 of adjacent separator discs 8 of the separator disc stack engage in each other. In this way, the separator discs of the stack of separator discs are also secured against rotation relative to one another radially further outwards by a form fit.

The hollow protrusions 83 themselves form the two corresponding form-fitting means of adjacent separator discs 8 in the stack of separator discs. The hollow protrusions 83 serve on the one hand as protrusions and on their opposite side as a form-fitting recess corresponding to the protrusion. The hollow protrusion 83 of a first separator disc 8 in the stack of separator discs thus engages as a projection in the recess of the corresponding hollow protrusions 83 in the neighboring separator disc 8.

The hollow protrusions 83 can be of closed design so that the separator disc 8 does not have a hole in their area. They then look like a kind of embossing.

According to the figures, the hollow protrusions 83 are formed on the underside of the separator discs 8. However, it is also conceivable to form them virtually rotated by 180°—on the upper side of the separator discs 8 (not shown). A part can also extend “upwards” and a part of the hollow protrusions 83 “downwards”.

Several of the hollow protrusions 83 per separator disc 8 can be formed circumferentially distributed on a common radius of the respective separator disc 8 (FIGS. 1, 3, 4). However, several hollow protrusions can also be formed circumferentially distributed on different radii of the separator discs 8.

According to a preferred variant, the hollow protrusions 83 can each be arranged in a radial extension of the web-like spacer elements 81, where they can have virtually no detrimental effect on the separation process in the circumferential area between the spacer elements.

The hollow protrusions 83 can have a spherical segment shape. However, they can also have an elongated cross-sectional shape. According to a particularly preferred embodiment, it is provided that the hollow protrusions have a wedge-shaped cross-section and extend essentially radially. Such a shape ensures particularly good circumferential centering of the separator discs 8 in the stack of separator discs.

The hollow protrusions designed in this way do not create any openings in the separator disc, so that the surface of the respective separator disc is closed in the area of the hollow protrusions.

The distributor base can have functional elements corresponding to the separator discs, for example edge recesses 712 in extension of the edge recesses 82 in the separator discs or spacers 711 corresponding to the spacers 81 on the separator discs. In addition, the distributor base 71 can have form-fitting means corresponding to the hollow protrusions 83, in particular “lugs” 713, as indentations or recesses on its conical surface, so that the lowermost separator disc 8 with its hollow protrusions 83 comes into engagement with the lugs 713 of the distributor base when stacked on the distributor 7, which also already centers the lowermost separator disc 8 well in the stack of separator discs.

The separator discs 8 can have the circumferentially distributed corresponding hollow protrusions 83, particularly in their outer circumferential areas, so that the separator discs are secured against rotation and fixed in position relative to each other in the circumferential direction, particularly in their outer area. Other positions of the hollow protrusions 83, such as halfway between the inner radius and outer radius of the disc, are also possible (not shown).

When the separator discs 8 are stacked on top of each other, the wedge-shaped hollow protrusion tip of one disc is placed in the hollow space of the corresponding hollow protrusion 83 of the neighboring separator disc 8, so that the discs are precisely rotationally aligned with each other.

The axial alignment of the separator discs 8 in the stack of separator discs can be optimized by designing the wall thicknesses and angles of the hollow protrusions 83 in such a way that when the hollow protrusions 83 are joined together, there is a distance between the adjacent separator discs 8 that corresponds to the height of the spacer elements 81. Such shaping is particularly easy to achieve if the separator discs 8 are designed as injection-molded parts manufactured using a plastic injection-molding process.

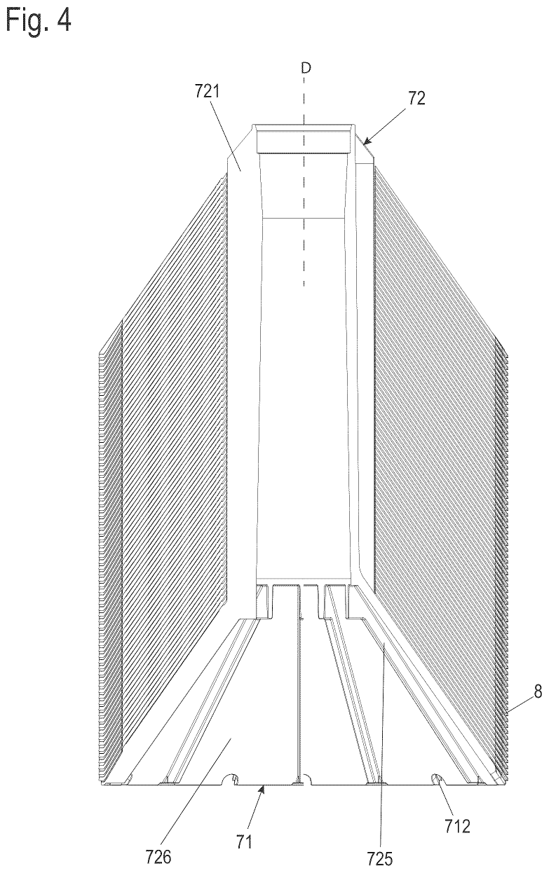

It is preferable to design the locking of the separator discs on the distributor shaft 72 (or distributor neck) in such a way that the separator disc 8 is designed without an offset on the inner circumference (and preferably on the outer circumference). Since the alignment of the discs to each other is ensured by the hollow protrusions 83, a very precise groove and feather key locking between separator disc 8 and distributor shaft 71 is no longer necessary. The fit and its tolerance between separator disc 8 and distributor shaft 71 can thus be designed in such a way that it can be easily realized with injection-molded parts and assembly and disassembly of the disc pack on the distributor shaft 71 can be easily carried out (see FIGS. 3 and 4). It is preferable that the spacer elements 81 are provided in radial extension of the ribs 721 of the distributor.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SYMBOLS

1 Separator insert
2 Housing
3 Rotor
4 Drum
5 Magnetic bearing devices
5a, 5b Stator magnet, rotor magnet
6 Magnetic bearing devices
6a, 6b Stator magnet, rotor magnet
7 Distributor
71 Distributor base
711 Spacer element
712 Edge recesses
713 Lugs
72 Distributor shaft
721 Ribs
725 Ribs
726 Channel
8 Separator disc
81 Spacer elements, webs
82 Edge recesses
83 Hollow protrusions
84 Recesses
9 Feed pipe
10, 11 Discharge lines
12,13 Discharge lines
14 Control device
15 Valve
D Rotary axis
LP, HP Phases
S Suspension

1-22. (canceled)

23. A separator disc for a centrifuge, the separator disc comprising:
a frustoconical shell-like main body having an inner circumference, an outer circumference, an inner surface, an outer surface, and one or more spacer elements,
wherein one or more hollow protrusions are formed on the frustoconical shell-like main body, wherein the one or more hollow protrusions have a greater axial extension than the one or more spacer elements, so that, in a stack of a plurality of the separator discs, the one or more hollow protrusions of adjacent separator discs are engageable into one another in a form-fitting manner,
wherein the separator disc is configured to be arranged in the stack of separator discs in a drum interior of a drum of the centrifuge to clarify or separate a substance mixture.

24. The separator disc of claim 23, wherein the frustoconical shell-like main body has an angle to an axis of rotation that is constant radially inwards, so that no crank is formed radially inwards on the separator disc, and wherein recesses are formed on the inner circumference of the separator disc.

25. The separator disc of claim 23, wherein the separator disc consists entirely or substantially of plastic or a plastic composite material.

26. The separator disc of claim 23, wherein the separator disc consists entirely or substantially of metal.

27. The separator disc of claim 23, wherein the one or more hollow protrusions are wedge-shaped.

28. The separator disc of claim 23, wherein the one or more hollow protrusions are in a shape of a spherical segment.

29. The separator disc of claim 23, wherein the inner and outer surfaces of the separator disc are closed in a region of the one or more hollow protrusions.

30. The separator disc of claim 23, wherein the one or more of the hollow protrusions are formed on the inner surface of the separator disc.

31. The separator disc of claim 23, wherein the one or more of the hollow protrusions are formed on the outer surface of the separator disc.

32. The separator disc of claim 23, wherein the one or more of the hollow protrusions are formed in a central or an outer radial region of the separator disc.

33. The separator disc of claim 23, wherein the one or more spacer elements are radially extending webs, and wherein the one or more hollow protrusions are provided in radial extension of the one or more spacer elements.

34. The separator disc of claim 23, wherein an arrangement of the one or more hollow protrusions on the inner or outer circumference of the frustoconical shell-like main body of the separator disc follows a same pitch as an arrangement of the one or more spacer elements.

35. The separator disc of claim 23, wherein a wall thicknesses and angles of the one or more hollow protrusions are designed in such a way that, when the one or more hollow protrusions of adjacent separator discs are joined together, a distance between the adjacent separator discs is produced corresponding to a height of the spacer elements.

36. A device comprising:
a distributor that is rotatable in operation; and
a separator disc stack of separator discs of a separator rotatable with the separator disc stack in the operation,
wherein each of the separator discs of the separator disc stack have
a frustoconical shell-like main body having an inner circumference, an outer circumference, an inner surface, an outer surface, and one or more spacer elements,
wherein one or more hollow protrusions are formed on the frustoconical shell-like main body, wherein the one or more hollow protrusions have a greater axial extension than the one or more spacer elements, so that, in the separator disc stack, the one or more hollow protrusions of an adjacent separator disc in the separator disc stack are engageable into one another in a form-fitting manner,
wherein the distributor has a distributor base and a distributor shaft,
wherein a lowermost separator disc of the separator disc stack rests on the distributor base, and
wherein further separator discs of the separator disc stack are stacked on the lowermost separator disc around the distributor shaft.

37. The device of claim 36, wherein the one or more hollow protrusions of the adjacent separator discs in the separator disc stack interlock positively and center the separator discs in the separator disc stack at least in a circumferential direction.

38. The device of claim 37, wherein the distributor base has one or more form-fitting elements corresponding to the one or more hollow protrusions or the one or more hollow protrusions of the lowermost separator disc, wherein the one or more hollow protrusions of the lowermost separator disc engage or receive the one or more form-fitting elements so that the lowermost separator disc is centered in a form-fitting manner on the distributor base.

39. The device of claim 36, wherein the distributor shaft includes ribs radially projecting radially from an outer circumference of the distributor shaft, wherein the ribs fully or partially engage around the separator discs of the separator disc stack on an inner circumference of the separator discs of the separator disc stack in a form-fitting manner with recesses on an inner circumference of the separator discs of the separator disc stack.

40. The device of claim 39, wherein the one or more spacer elements are provided in radial extension of the ribs of the distributor shaft projecting radially from the outer circumference of the frustoconical shell-like main body.

41. The device of claim 36, wherein the distributor consists entirely or substantially of plastic or a plastic composite material.

42. The device of claim 36, wherein the distributor consists entirely or substantially of metal.

43. A centrifuge comprising:
a drum;
a distributor that is rotatable in operation; and
a separator disc stack of separator discs of a separator rotatable with the separator disc stack in the operation, wherein the distributor and separator disc stack are arranged in an interior of the drum,
wherein each of the separator discs of the separator disc stack have
a frustoconical shell-like main body having an inner circumference, an outer circumference, an inner surface, an outer surface, and one or more spacer elements,
wherein one or more hollow protrusions are formed on the frustoconical shell-like main body, wherein the one or more hollow protrusions have a greater axial extension than the one or more spacer elements, so that, in the separator disc stack, the one or more hollow protrusions of an adjacent separator disc in the separator disc stack are engageable into one another in a form-fitting manner,
wherein the distributor has a distributor base and a distributor shaft,
wherein a lowermost separator disc of the separator disc stack rests on the distributor base, and
wherein further separator discs of the separator disc stack are stacked on the lowermost separator disc around the distributor shaft.
